(19) United States
(12) Patent Application Publication
(10) Pub. No.: US 2020/0269476 A1
(43) Pub. Date: Aug. 27, 2020

(54) Manufacturing Method For Highly Filled Urethane Foams

(71) Applicant: Magna Seating Inc, Aurora (CA)

(72) Inventors: Eric Kozlowski, Oakland Township, MI (US); Matthew Finneran, Oxford, MI (US); Rene Chauvin, Desbarats (CA)

(21) Appl. No.: 16/496,478

(22) PCT Filed: Mar. 23, 2018
(86) PCT No.: PCT/US2018/023943

§ 371 Date: Sep. 23, 2019

Related U.S. Application Data
(60) Provisional application No. 62/475,956, filed on Mar. 24, 2017.
(60) Provisional application No. 62/538,245, filed on Jul. 28, 2017.

(51) Int. Cl. B29C 44/34; B29C 44/56

(52) U.S. Cl. CPC B29C 44/3442; B29K 2075/00; B29C 44/5627

(57) ABSTRACT

A manufacturing method for forming highly filled foam through dual axis mixing of precursor chemicals and fillers to form end products and parts. The manufacturing method provides an improved highly filled foam material as well as improved methods for shaping such foam into various parts and end products. In this manufacturing method, a mixing container (33) may be used to mold highly filled foam directly into a cylindrical shape (40) for processing into parts and end products, or may be used to transport uncured highly filled foam to a separate molding station (50) to form molded end products (56) which incorporate well-mixed, highly filled foam therein

### CROSS-REFERENCE TO RELATED APPLICATIONS

This application claims priority to U.S. provisional patent application No. 62/475,956, filed Mar. 24, 2017, and U.S. provisional patent application No. 62/538,245, filed Jul. 28, 2017, the disclosures of which are incorporated by reference in their entirety.

### TECHNICAL FIELD

The invention relates to an improved method for forming highly filled foams, and for forming such foams into parts and end products, such as automotive foam sheeting and pads for seats.

### BACKGROUND

During the manufacture of foam as well as the manufacture of products or parts made from such foam, it may be desirable to include fillers within the foam to thereby form highly filled foams. Generally, fillers impact and enhance the mechanical properties of the foam, which are otherwise difficult or impossible to achieve. However, manufacturing of highly filled foams is difficult to do in large-scale production volumes. Current attempts to create highly filled foams result in a foam product that is not homogenous and has inconsistent or poor strength properties. One problem is that mixing of extremely high viscosity chemical streams creates parts that have resin rich areas and filler rich areas, and is not consistent part-to-part.

Known mixing techniques, such as high pressure impingement mixing and low pressure high shear mixing, cannot properly blend the high viscosity, paste-like reactant materials being mixed to form highly filled foam. Trapped air within the paste is a constant source of inconsistency.

In addition to these problems associated with the manufacture of highly filled foam, the manufacture of foam products into cylindrical blocks and other shapes also have problems associated therewith. As one example, when forming cylindrical blocks of foam for subsequent processing into end products, such as foam sheets, the current state of the art can be inefficient and result in significant waste of foam.

In one example, referring to FIGS. 1 and 2, slab foam is known to be manufactured continuously in large buns 6′×5′×100′ long. In this manufacturing step, the foam compound is initially fed to a forming station 10 having a generally rectangular mold 11 through which the foam compound is initially fed. In FIG. 2, a large bun 12 of cured foam is discharged from a conveyor station 14. As noted, the bun 12 has a large cross sectional shape and a significant length such as 100 feet, which can be too large for direct processing into parts and, end products. As seen in FIG. 3, these large buns 12 are cut into rectangular blocks 13. The foam blocks 13 may then transit along a conveyor 14 for further processing or reshaping into various parts and end products.

For some end products, it is desirable to reshape the foam block 13 in an intermediate processing step before finally shaping the foam into an end product. Generally referring to the example of FIG. 4, the rectangular blocks 13 are skived into cylindrical shaped blocks 15, and the cylindrical shaped blocks 15 are peeled/skived into trim padding 16, which is generally formed as thin flexible sheets. There is a large amount of waste in this process by reshaping the original bun 12 into rectangular blocks 13 which are then skived into the cylindrical blocks 15.

In this known process, a cutting machine 17 may be provided which includes a support roller 18 that supports the cylindrical block 15. The cutting machine 17 includes a cutter unit 19 that makes a thin cut about the circumference of the block 15 to peel or skive the block 15 and thereby form a continuous, flexible thin and flat strip 20 of foam that is discharged and rolled up into a cylindrical sheeting roll 21 to define the trim padding 16.

With this process, formation of a cylindrical block requires three steps of forming the bun 12, cutting the bun 12 into the smaller rectangular blocks 13 and then the rectangular blocks are skived to form the cylindrical shaped blocks 15. Also, use of this process to make highly filled foam is difficult due to the challenges in thoroughly mixing the foam compound when forming a large bun. Therefore, it is an object of the invention to provide an improved manufacturing method for making highly filled foams and shaping the highly filled foam into parts and final end products.

### SUMMARY

The invention relates to improved manufacturing methods for both forming highly filled foam and shaping such foam into various parts and end products. In one aspect, the inventive method bypasses the first three steps of manufacturing a cylinder from a large bun by instead molding highly filled foam directly into a cylinder. As a result, there are significant material, machine and labor savings using this new manufacturing method, which permits the direct manufacture of foam logs or cylinders. With this method, it is not necessary to perform intermediate steps of reshaping a rectangular foam block into an intermediate shape such as a cylinder. Rather, directly after forming the foam logs, the method may slit the logs into a continuous sheet.

When forming the highly filled foam, the uncured foam may be loaded into a mixing container having the desired cylindrical shape. In a first aspect of the invention, this mixing container may be formed by a 5 gallon bucket or pail into which the chemicals and fillers for the uncured foam are loaded and then cured to form the foam log. This log may then be peeled or skived into a thin foam sheet, wherein 5 gallon buckets or larger can yield 20+ linear feet of foam sheet or padding. In a second aspect, the mixing container is used to mix the highly filled foam, wherein the uncured foam is then removed from the mixer and poured into a separate mold for shaping into an end product.

Preferably, the inventive manufacturing method make uses of new Dual Axis mixing techniques, which are brand new to the foam industry. In the preferred mixing machine, the mixing container may be used as the mold, wherein the preferred dual axis mixing machine allows loading of the mixing container therein. In this dual axis mixing technique, centrifugal force is created by spinning the material in the mixing container in two opposite axes simultaneously, which produces a high shear blending effect and therefore thoroughly mixes the materials inside the container or pail, while avoiding the inconsistencies associated with the known techniques described above.

With these dual axis mixing techniques, degassing happens as a result of the counter-current mixing action. As such, a number of advantages are provided. These advantages include: higher filler loading is possible (60+% by weight of the final product); higher viscosities are possible; lower overall densities; more consistent product; no premixing of chemicals is required; and the mixing process is very efficient in requiring 30 seconds or less of mixing time. Since a preferred mixing unit can handle small batches with smaller mixing containers, the dual axis mixing machine may have a smaller scale, such that manufacturing could be located close to the end use trim plants, wherein the foam sheets may be processed for use as trim for various products such as automotive seating.

For both aspects of this inventive manufacturing method, the first step is to load precursor chemicals and any fillers by a foam dispensing unit into a mixing container preferably having a cylindrical container cavity, such as a 5 gallon pail which can serve as a transportable mold or allow transport of the mixed foam to a separate mold station. The preferred mixing machine is a dual axis mixer sold commercially as a State Mix VM-1000 Dual Axis Centrifugal Mixer. In the second step, the mixing container is placed into the State Mix VM-1000 or other suitable mixing machine, which is operated to mix the container and contents for 30 seconds. It will be understood that the mixing container might also be both loaded and mixed within a suitable mixing machine or mixer which performs both dispensing of precursor chemicals and fillers, and mixing thereof.

In a first aspect of the invention, the next steps are to remove the mixing container from the mixer and free rise the foam, and then cure for a predetermined time, preferably of 5-6 minutes. The next step is to demold the foam cylinder, and follow with a long term cure. Once the foam is removed from the mixing container and fully cured to form the foam log, it is also desirable to trim the sides or ends of the foam cylinder or log. Therefore, in this one molding and curing process, the foam cylinder or log is formed without requiring additional processing and reshaping before the next step of loading the foam log into a cutting machine for continuous rotational slitting of the foam log into the trim pad or sheet having the desired thickness.

The trim pad or sheet may then be laminated with a scrim backing for various uses such as in seating or automotive seating. Further, the foam sheet with scrim backing may subsequently be die cut to form die cut parts for sewing into an assembly such as an assembly used in automotive seating.

In a second aspect of the invention, the uncured foam may be transferred from the mixing container and poured into a separate mold to form an end product formed of highly filled foam. Similar to the above description, the first step is to load the precursor chemicals into the mixing container, such as a 5 gallon pail which serves as a transportable mixing container. The preferred mixing machine is the dual axis mixer sold commercially as a State Mix VM-1000 Dual Axis Centrifugal Mixer. In the second step, the mixing container is placed into the State Mix VM-1000, which is operated to mix the container and contents for a suitable mixing time of preferably 30 seconds. The mixing container is then removed from the mixer and the uncured foam material is poured into a conventional foam tool, such as a tool used to form a seating cushion or seat pad. The foam is then cured for a suitable curing time such as 5-6 minutes. The next step is to demold or remove the foam from the tool, and then the foam is subjected to a long term cure.

As a result, a pad is shaped and molded in the tool wherein the entire molded pad now contains highly-filled foam. The particular fillers selected can depend upon the desired mechanical improvements being sought. Examples of fillers include graphite, aluminum, silver, copper, or other conductive fibers to enhance the thermal conductivity of the foam pad or sheets of foam padding. With these fillers, the foam pad or sheets of padding may then be enhanced for improved heating of the seating pad or sheets. A thermoelectric element may be connected to the seat in a manner which transfers heat to the seat pad for heating or even removes heat from the seat pad for cooling. Due to the improved thermal conductivity of the foam pad or foam sheeting according to the present invention, the foam pad or sheeting exhibits improved heating or cooling characteristics.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a front perspective view of a known foam molding machine for forming large buns of foam;

FIG. 2 is a front perspective view of a conveyor unit and bun being discharged from a foam molding machine;

FIG. 3 is a side perspective view of a rectangular foam block on a conveyor unit;

FIG. 4 is a side perspective view of a cutting machine with a cylindrical foam block supported thereon;

FIG. 5 is a front view of a foam dispensing machine with mixing containers supported thereon;

FIG. 6 is a front perspective view of a dual axis mixing machine;

FIG. 7 diagrammatically illustrates a mixing container being loaded in the mixing machine;

FIG. 8 is a front perspective view of the mixing machine with a loaded mixing container accessible therein;

FIG. 9 is a front perspective view of a cylindrical foam log removed from said mixing container;

FIG. 10 is a front perspective of a cutting machine for the foam log;

FIG. 11 is a side perspective view of a roll of foam sheeting with a scrim backing;

FIG. 12 is a top view of die cut parts formed from said foam sheeting;

FIG. 13 is a perspective view of a mold tool;

FIG. 14 is a perspective view of the mold tool with a molded end product; and

FIG. 15 is a perspective view of a seat pad formed by the present invention.

Like reference numerals are used throughout the Figures to denote similar elements and features.

### DETAILED DESCRIPTION OF EXAMPLE EMBODIMENTS

Referring to FIGS. 5-8, the invention relates to an improved manufacturing method for forming highly filled foam through dual axis mixing of the precursor chemicals used to form the foam. As described hereinafter, the manufacturing method of the present invention provides an improved highly filled foam material as well as improved methods for shaping such foam into various parts and end products.

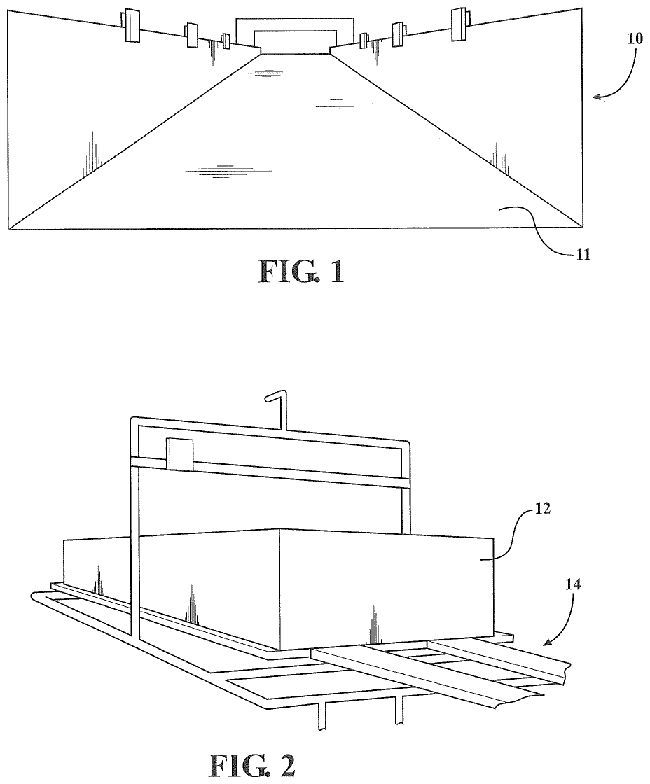

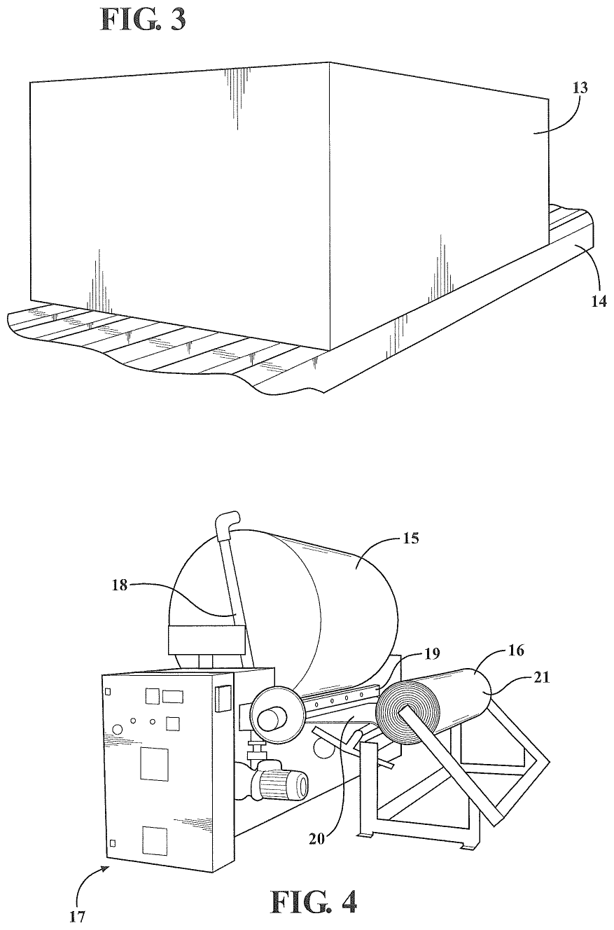

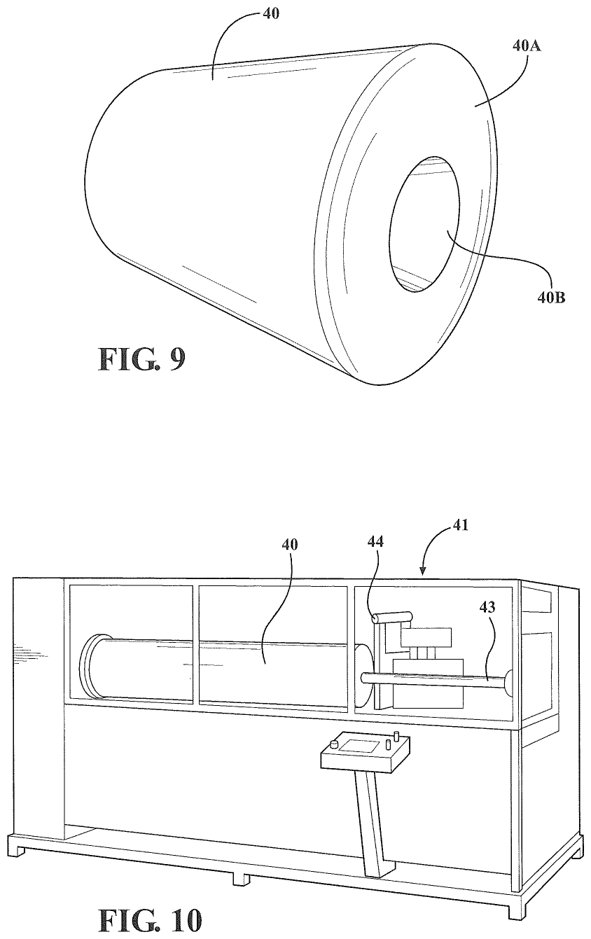

As previously described, the inventive method bypasses the first three steps of manufacturing generally depicted in FIGS. 1-4 by molding the highly filled foam directly into a cylindrical shape (see FIG. 9). As a result, there are significant material, machine and labor savings due to the direct manufacture of the highly filled foam in a cylindrical shape according to a first aspect of the invention. With this method, it is not necessary to perform intermediate steps of reshaping a rectangular foam block into an intermediate shape such as a cylinder as previously described relative to FIGS. 3 and 4. In a second aspect of the invention described below, the uncured highly filled foam may be transferred directly after mixing to a separate molding station to form molded end products which incorporate well-mixed, highly filled foam therein.

In more detail, both aspects of the invention make use of dual axis mixing techniques to form highly filled foam that is suitable for the manufacture of various end products and parts. Referring to FIG. 5, a foam dispensing unit 30 is illustrated which includes a dispenser assembly 31 that is configured to dispense metered quantities of precursor chemicals for use in creating the highly filled foam.

Further, the dispenser assembly 31 may be configured to also dispense metered quantities of a suitable fillers which enhance the characteristics of the foam so that the foam is transformed into a highly filled foam. The particular fillers selected can depend upon the desired mechanical improvements being sought. Examples of fillers include graphite, aluminum, silver, copper, or other conductive fibers to enhance the thermal conductivity of the highly filled foam. With these fillers, the foam may then be enhanced for improved heating or cooling characteristics, which may have particular use in various parts and end products, such as a seating pad and surface scrim used in automobile components.

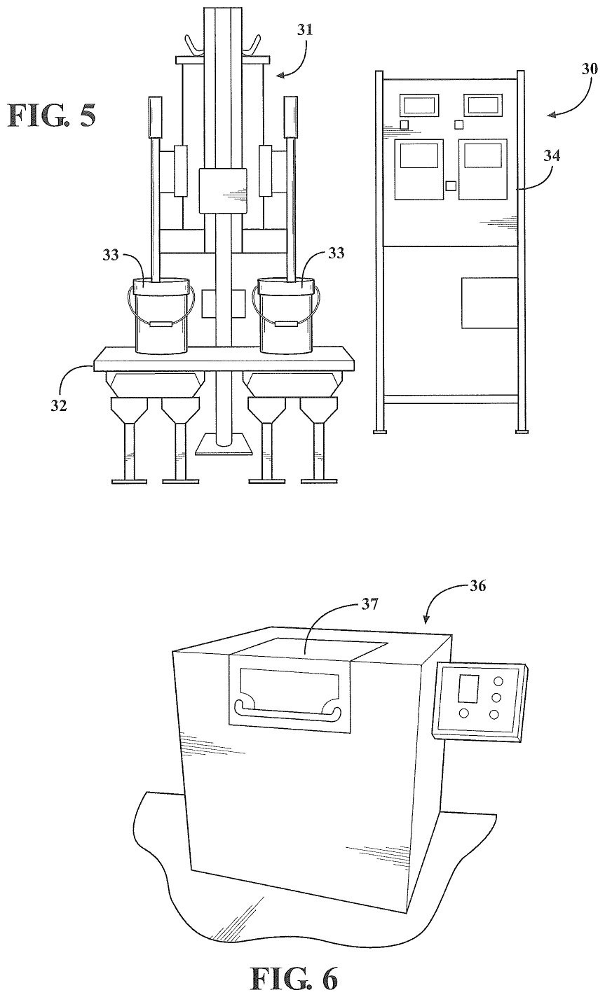

The dispensing unit 30 includes a conveyor or other support 32 on which a quantity of mixing containers 33 may be supported below the dispenser assembly 31. The first step is to load precursor chemicals from the dispensing assembly 31 into the mixing containers 33 for subsequent mixing and curing. The dispensing assembly 31 also may be operated to dispense the fillers into the mixing containers 33 in accord with the present invention, wherein the fillers result in the manufacture of a highly filled foam. The precursor chemicals and fillers may be dispensed simultaneously together or separately one after the other depending upon the configuration and operation of the dispensing unit 30. The dispensing unit 30 includes a control panel 34 to control the dispensing step, and prepare the mixing containers 33 for subsequent mixing in a suitable mixing machine 36 (FIG. 6).

In the present invention, the mixing container may be of any suitable size but preferably may be a 5 gallon pail. In the first aspect of the invention, the mixing container 33 also may serve as a transportable mold which defines a cylindrical mold cavity. In the second aspect of the invention described below, the mixing containers 33 may be used to transport the uncured foam to a molding station as described below. Further, each mixing container 33 is closable by a lid or other like closures 33A (see FIG. 8).

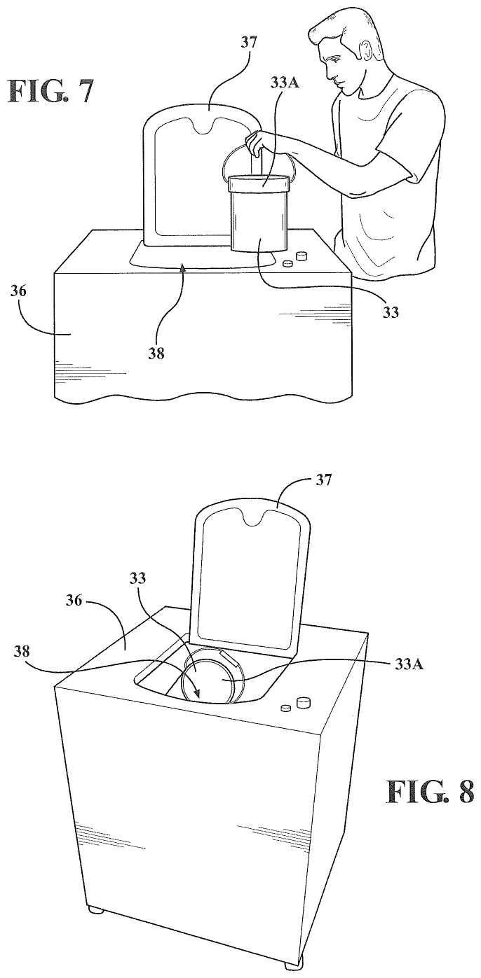

Referring to FIGS. 6-8, the mixing machine 36 is disposed downstream of the dispensing unit 30 and includes an openable access door or panel 37 that provides access to an interior compartment or mixing chamber 38. The mixing chamber 38 is sized to receive at least one of the mixing containers 33, which may be placed manually into the mixing chamber 38 (see FIG. 7). As an alternative, transfer of the mixing containers 33 to the mixing machine 36 may be automated. Notably, the mixing containers 33 have an open top as seen in FIG. 5 for initial loading, which is later covered with a lid 33A to contain the foam ingredients and fillers therein for subsequent mixing.

Preferably, the inventive manufacturing method makes use of dual axis mixing techniques, which are believed to be brand new to the foam industry. In a dual axis mixing technique, the mixing machine 36 is configured and operated such that a centrifugal force is created by spinning the material in the mixing container 33 in two opposite axes simultaneously, which produces a high shear blending effect and therefore thoroughly mixes the materials, i.e. precursor chemicals and fillers, inside the mixing container or pail 33, while avoiding the inconsistencies associated with the known techniques described above. As a result, the highly filled foam is uniformly blended with highly desirable consistency.

The preferred mixing machine 36 is a dual axis mixer sold commercially as a State Mix VM-1000 Dual Axis Centrifugal Mixer as shown in FIGS. 5-7. Once the foam precursor chemicals and fillers are dispensed into the mixing container 33 by the dispensing unit 30, the mixing container 33 is preferably transferred to and placed into the State Mix VM-1000 or other suitable mixing machine, which is operated to mix the closed mixing container 33 and contents thereof for 30 seconds. With this mixing machine 36, a relatively small amount of mixing time is required to achieve uniform consistency of the precursor chemicals and fillers. While the dispensing unit 30 and mixing machine 36 are shown as separate machines, it will be understood that the dispensing unit 30 and mixing machine 36 may be integrated such that the mixing container 33 can be both loaded and mixed within a suitable mixing machine or mixer without requiring physical transport of the mixing container 33 from the dispensing station to the mixing station.

With these dual axis mixing techniques, degassing happens as a result of the counter-current mixing action. As such, a number of advantages are provided. These advantages include: higher filler loading is possible (60+% by weight of the final product); higher viscosities are possible; lower overall densities are achieved; more consistent product results; no premixing of chemicals is required; and the mixing process is very efficient in requiring 30 seconds or less of mixing time. Since this preferred mixing machine 36 can handle small batches with smaller mixing containers 33, the dual axis mixing machine 36 may be built to a smaller physical scale, such that a manufacturing line for the highly filled foam could be located close to the end use trim plants.

Referring to FIGS. 9 and 10, the first aspect of the invention uses the mold containers 33 as molds for shaping the highly filled foam into a cylindrical log or block 40 (FIG. 9). Therefore, during the step of forming the highly filled foam using the mixing machine 36, the uncured foam is loaded into a mixing container 33 having the desired shape which preferably is a cylindrical shape so that after curing of the foam, the cylindrical log 40 has a shape corresponding to the shape of the mixing container 33. In this first aspect of the invention, the mixing container 33 may be formed by a 5 gallon bucket or pail into which the chemicals and fillers for the uncured foam are loaded by the dispensing unit 30, mixed in the mixing machine 36, and then cured to form the foam log 40 as described in more detail below. Generally with reference to FIG. 10, this foam log 40 may then be peeled or skived into a thin foam sheet by a cutting machine 41. By peeling or skiving the foam log 40, 5 gallon buckets or larger can yield 20+ linear feet of foam sheet or padding from a single foam log 40.

More particularly, the mixing container 33 is subjected to the mixing process performed by the mixing machine 36, wherein the foam is mixed but still uncured. The uncured foam essentially is a flowable liquid. The next steps are to remove the mixing container 33 from the mixing machine 36 such as by manually removing the mixing container 33 as generally seen in FIG. 7. The mixing container 33 is then allowed to set in order to free rise the foam, and then initially cure for a predetermined time, preferably for an initial curing time of 5-6 minutes. The next step is to demold the foam cylinder by removing the foam cylinder from the mixing container 36. The foam cylinder is then subjected to a long term cure for a final cure time of a suitable time period, which time is dependent upon the particular foam being manufactured. Once the foam cylinder is removed from the mixing container 33 and fully cured to form the foam log 40, it is also desirable to trim the sides or ends 40A of the foam cylinder or log 40. This is desirable to provide a uniform shape for subsequent cutting or skiving. Also, the foam log 40 might be provided with a central bore 40B to facilitate mounting within the cutting machine 41. The central bore 40B might be formed by a suitable machine tool or by insertion of a preform or insert into the mixing container 33 prior to the initial curing step.

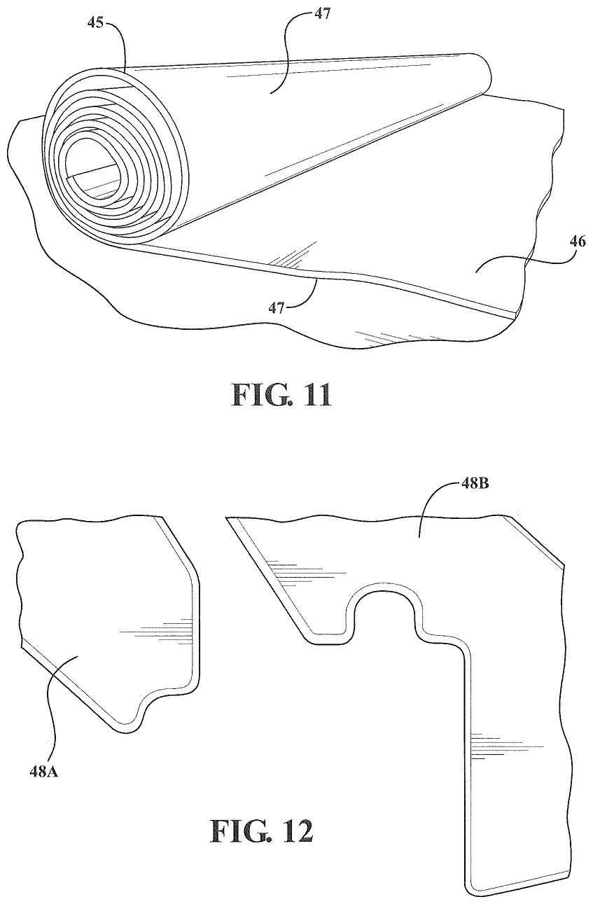

The cylindrical log 40 may then be mounted in the cutting machine 41, which includes a support shaft 43 that supports the cylindrical log 40. The cutting machine 41 includes a cutter unit 44 that makes a thin cut about the circumference of the log 40 to peel or skive the log 40 and thereby form a continuous, flexible thin sheet of foam that is discharged and rolled up into a cylindrical sheeting roll 45 (FIG. 11) to form the trim sheet or padding 46.

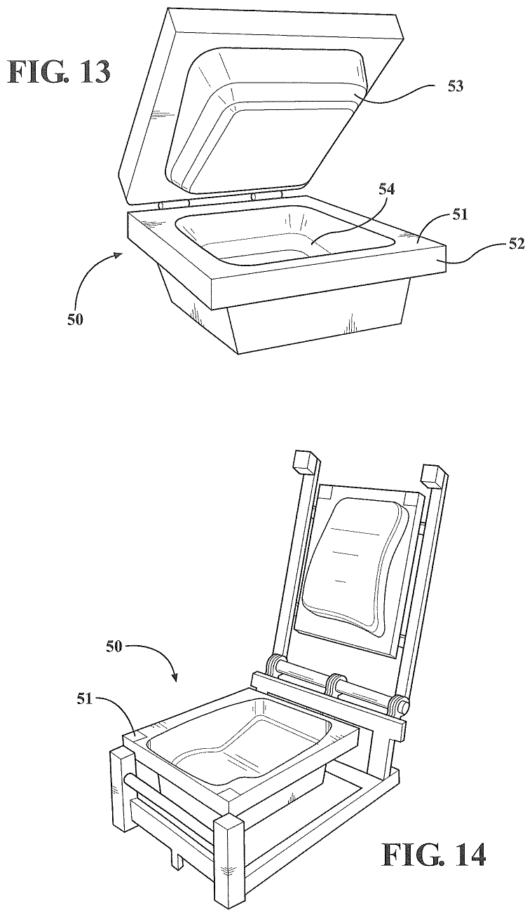

The trim pad or sheet 46 may then be laminated with a scrim backing 47 for various uses such as in seating, particularly automotive seating. Further, the foam sheet 46 with scrim backing 47 may subsequently be die cut to form die cut parts 48A and 48B (FIG. 12) for sewing into an assembly such as an assembly used in automotive seating.

Therefore, in this one molding and curing process, the foam cylinder or log 40 is formed and shaped by the molding container 33, which serves the second function of a mold for the highly filled foam. This method does not require additional processing and reshaping before loading the foam log 40 into a cutting machine 41 for continuous rotational slitting of the trim pad or sheet 46 to the desired thickness.

In a second aspect as shown in FIGS. 13 and 14, the mixing container 33 is used to mix the highly filled foam in the mixing machine 36 as described above. However, the uncured foam is then removed from the mixing container 33 and poured at a separate mold station 50 for shaping into an end product.

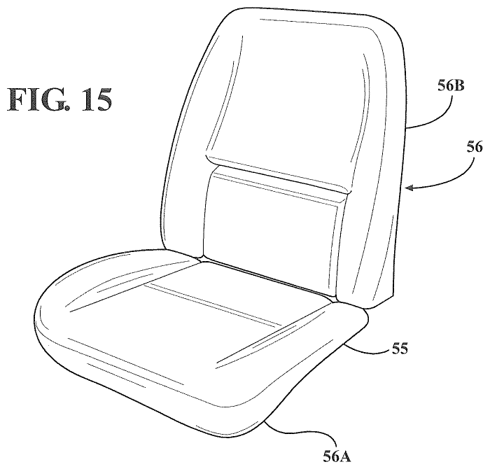

Consistent with the above description, the first step is to load precursor chemicals and fillers into the mixing container 33 by the dispensing unit 30, wherein the mixing container 33 may be the 5 gallon pail which serves as a transportable mixing container. The preferred mixing machine is the dual axis mixer sold commercially as a State Mix VM-1000 Dual Axis Centrifugal Mixer. In the second step, the mixing container 33 is placed into the State Mix VM-1000, which is operated to mix the closed container 33 and contents for a mixing period of preferably 30 seconds. The mixing container 33 is then removed from the mixing machine 36 (FIG. 7) and the uncured foam material is poured into a foam molding tool 51 at the mold station 50. The tool 51 may be any suitable mold tool but typically comprises a lower mold 52 and an upper mold 53 that are matable to define a mold cavity 54 into which the uncured foam is poured. The lower and upper molds 52 and 53 and associated mold cavity 54 may shape the foam into a variety of parts or end products. In one example, the tool 51 is configured and used to form a foam part 55 shaped for use as a seating cushion or seat pad (FIGS. 15 and 16). The foam is then cured in the tool 51 for an initial cure time of a suitable time period such as 5-6 minutes. The next step is to demold the foam part 55 from the tool 51, and then the foam part 55 is subjected to a long term cure for a final cure time of a suitable time period.

As a result, a seating pad 56 is shaped and molded in the tool wherein the entire seating pad 56 is now defined by highly-filled foam. This pad 56 may comprise a seat portion 56A and/or back portion 56B, and the particular fillers selected can depend upon the desired mechanical improvements being sought. Examples of fillers include graphite, aluminum, silver, copper, or other conductive fibers to enhance the thermal conductivity of the foam pad. With these fillers, the foam part 55 may then be enhanced such as for improved heating or cooling of the seating pad 56. A thermoelectric element may be connected to the seating pad 56 in a manner which transfers heat to the seating pad 56 or even removes heat from the seating pad 56 for cooling. Due to the improved thermal conductivity of the foam pad 55 according to the present invention, the foam pad 55 exhibits improved heating or cooling characteristics.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

1. A manufacturing method for forming highly filled foam comprising the steps of:
dispensing one or more precursor chemicals and one or more fillers suitable to form a highly filled foam into a portable mixing container with a dispensing unit;
preparing said mixing container for mixing in a mixing machine;
mixing said precursor chemicals and said fillers with said mixing machine using a dual axis mixing technique with which said mixing container is displaced about multiple axes to thoroughly mix said precursor chemicals and said fillers into an uncured highly filled foam;
curing said uncured highly filled foam within a mold chamber defined by one of said mixing container and a mold tool; and
forming an end product from said highly filled foam after said curing.

2. The method according to claim 1, wherein said dispensing unit comprises a dispenser assembly configured to dispense metered quantities of said precursor chemicals and said fillers into said mixing container for creating said highly filled foam.

3. The method according to claim 2, wherein said fillers enhance said highly filled foam for modifying said heating or cooling characteristics to increase heat transfer through said end product.

4. The method according to claim 2, wherein said filler comprises thermally conductive fibers to enhance a thermal conductivity of said highly filled foam for increased heating or cooling transfer.

5. The method according to claim 4, wherein said conductive fibers being a conductive material comprising at least one of graphite, aluminum, silver, and copper.

6. The method according to claim 1, wherein said mixing container has an open top for loading in said dispensing unit, which is later covered with a closure to contain said one or more precursors and fillers therein for subsequent mixing in said mixing machine.

7. The method according to claim 1, further including the step of transporting said mixing container with said uncured highly filled foam from said mixing machine to said mold tool and pouring said uncured highly filled foam into said mold chamber of said mold tool for said curing step

8. The method according to claim 7, wherein said mold tool is configured to form a foam part shaped as one of a seating pad or sheet, which is enhanced by said fillers, which increase said thermal conductivity for increased heat transfer through said seating pad or sheet.

9. The method according to claim 1, wherein said forming step is performed by the steps of demolding said highly filled foam from said mixing container as a foam cylinder, and after curing of said highly filled foam, processing said foam cylinder into said end product.

10. The method according to claim 9, wherein said mixing container serving as a transportable mold which defines said mold chamber and shapes said highly filled foam into said foam cylinder after said curing step.

11. The method according to claim 9, further comprising the steps of:
free rising said highly filled foam within said mixing container;
initially curing said highly filled foam within said mixing container for an initial curing time to form said foam cylinder within said mixing container;
demolding said foam cylinder from said mixing container by removing said foam cylinder from said mixing container;
finally curing said foam cylinder for a final cure time; and
after said final curing, performing said forming step on to form said end product.

12. The method according to claim 11, wherein said forming step comprises the steps of:
processing said foam cylinder in a cutting machine to form a continuous, flexible thin sheet of foam;
rolling said sheet of foam into a cylindrical sheeting roll to form foam padding;
laminating said foam padding with scrim; and
die cutting said foam padding into die cut parts which define said end product.

13. A manufacturing method for forming highly filled foam comprising the steps of:
dispensing one or more precursor chemicals and one or more fillers suitable to form a highly filled foam into a portable mixing container with a dispensing unit, said filler comprising thermally conductive fibers to enhance a thermal conductivity of said highly filled foam for increased heating or cooling transfer;
preparing said mixing container for mixing in a mixing machine;
mixing said precursor chemicals and said fillers with said mixing machine using a dual axis mixing technique with which said mixing container is displaced about multiple axes to thoroughly mix said precursor chemicals and said fillers into an uncured highly filled foam;
curing said uncured highly filled foam within a mold chamber defined by one of said mixing container and a mold tool; and
forming an end product from said highly filled foam after said curing, said fillers enhancing said highly filled foam for improved heating or cooling characteristics to increase heat transfer through said end product

14. The method according to claim 13, wherein said conductive fibers are a conductive material comprising at least one of graphite, aluminum, silver, and copper.

15. The method according to claim 13, further including the step of transporting said mixing container with said uncured highly filled foam from said mixing machine to said mold tool and pouring said uncured highly filled foam into said mold chamber of said mold tool for said curing step

16. The method according to claim 13, wherein said end product is shaped as one of a seating pad or sheet, which is enhanced by said fillers, wherein said fillers increase said thermal conductivity of said end product for increased heat transfer through said seating pad or sheet.

17. The method according to claim 13, wherein said forming step is performed by the steps of demolding said highly filled foam from said mixing container as a foam cylinder, and after curing of said highly filled foam, processing said foam cylinder into said end product during said forming step.

18. The method according to claim 17, further comprising the steps of:
free rising said highly filled foam within said mixing container;
initially curing said highly filled foam within said mixing container for an initial curing time to form said foam cylinder within said mixing container;
demolding said foam cylinder from said mixing container by removing said foam cylinder from said mixing container;
finally curing said foam cylinder for a final cure time; and
after said final curing, performing said forming step on said foam cylinder to form said end product.

19. The method according to claim 18, wherein said mixing container serving as a transportable mold which defines said mold chamber and shapes said highly filled foam into said foam cylinder after said curing step.

20. The method according to claim 19, wherein said forming step comprises the steps of:
processing said foam cylinder in a cutting machine to form a continuous, flexible thin sheet of foam;
rolling said sheet of foam into a cylindrical sheeting roll to form foam padding;
laminating said foam padding with scrim; and
die cutting said foam padding into die cut parts which define said end product.
